(19) United States
(12) Patent Application Publication
(10) Pub. No.: US 2009/0284004 A1
(43) Pub. Date: Nov. 19, 2009

(54) DOUBLE CONTAINMENT SYSTEM, FITTINGS FOR FLUID FLOW COMPONENTS AND ASSOCIATED METHODS

(76) Inventors: Tom M. Simmons, Kamas, UT (US); John M. Simmons, Marion, UT (US); David M. Simmons, Francis, UT (US)

Correspondence Address: TRASKBRITT, P.C., P.O. BOX 2550, SALT LAKE CITY, UT, 84110, US

(21) Appl. No.: 12/120,851

(22) Filed: May 15, 2008

(51) Int. Cl. F16L 7/02; F16D 1/09; F16L 15/08; B23P 17/00

(52) U.S. Cl. 285/123.15; 403/11; 403/3; 29/527.1

(57) ABSTRACT

A method and apparatus for joining the ends of concentric inner and outer tube to a double containment fitting are disclosed, as are related methods of fabrication and systems. The apparatus uses a threaded coupling to compressively engage and seal the ends of both the inner and outer tubes to the double containment fitting. The double containment fitting includes inner and outer noses and a threaded annular body and annular nut. The inner nose may be at least partially inserted within a flared end of the inner tube, and the outer nose may encircle the inner tube and be inserted within the flared end of the outer tube. The inner and outer noses and the inner and outer tubes may be engaged in a relationship within bores through the annular body and the annular nut. Threadably engaging the annular nut with the annular body may establish seals between the components.

### TECHNICAL FIELD

The present invention relates generally to the coupling of fluid flow components. More particularly, the present invention relates to polymeric fittings for coupling polymeric fluid flow tubing. Embodiments of the present invention relate especially to polymeric fittings for coupling concentric inner and outer polymeric tubes, containment systems including the same, and associated methods.

### BACKGROUND

Numerous industries utilize fitting arrangements in many applications to compressively seal the ends of non-threaded tubing. In particular, fitting arrangements of this type are used extensively in the semiconductor processing industry, where plastic tubes are used to confine dangerous fluids including, for example, fluids that are corrosive, highly acidic, at a high temperature, and/or under significant pressure. In applications such as semiconductor processing, the fluids involved react with and/or may be contaminated by the use of metallic components and conventional fittings. Thus, in such industries, plumbing components are often made of highly inert materials such as fluoropolymers (e.g., PFA and PTFE) for wetted components.

Containment integrity becomes critical in processes using caustic and dangerous fluids. Under such conditions, the use of concentric tubing is well known. In a concentric tube arrangement, outer tubing surrounds a given length of inner tubing that may be transporting fluid. This arrangement may provide containment from internal leaks and/or protection against external damage. The outer tube may additionally carry heated or cooled fluids used to heat or cool the fluids flowing through the inner tube. Thus, it is desirable under these types of settings to use fitting arrangements with the ability to seal concentric inner and outer plastic tubing against leaks.

One conventional fitting for sealing concentric inner and outer plastic tubes, is disclosed in U.S. Pat. No. 5,498,036 to Kingsford. Specifically, the Kingsford fitting comprises concentric tubes and three additional members: an annular fitting body, an intermediate annular body, and an annular nut. The annular fitting body has a circular bore extending therethrough, a cylindrical nose portion on one end, and external threads. The intermediate annular body has a circular bore extending therethrough, a cylindrical nose portion on one end, a collar on the opposing end, and both internal and external threads. The annular nut has a circular bore extending therethrough, a shoulder on one end, and internal threads. The inner tube may be compressively engaged between the cylindrical nose portion of the annular fitting body and the collar of the intermediate annular body when the annular fitting body is threaded into the intermediate annular body. Similarly, the outer tube may be compressively engaged between the cylindrical nose portion of the intermediate annular body and the shoulder of the annular nut when the intermediate annular body is threaded into the annular nut. Thus, both the inner and outer tubes are sealed in one fitting.

Double containment fittings like the one described above, that feature multiple threading engagements, possess some inherent problems. Fluoropolymers are relatively soft materials. The softness of the material makes it difficult to hold tolerances and shape while machining. In addition, the material's high coefficient of thermal expansion prohibits high-speed machining due to frictionally induced heating and expansion of the material. Thus, additional thread cutting passes add significantly to the time required to machine a single fitting unit. The probability that a flaw in a threaded engagement will cause a hazardous leak is also increased with each additional threaded engagement. Every threaded connection has a potential to leak, thus, the more threaded connections there are in a containment system, the greater the probability that there will be a leak.

As may be appreciated, it would be advantageous to provide a fitting arrangement for jointly sealing concentric inner and outer plastic tubing with minimal use of threaded couplings.

### BRIEF SUMMARY OF THE INVENTION

Embodiments of the invention relate to a double containment fitting for the ends of concentric tubing, systems including the same, methods of sealing the end of concentric tubing, and methods of making a double containment fitting.

According to one embodiment of the invention, a double containment fitting for joining to the ends of concentric inner and outer tubes comprises an annular body with a first end portion, a second, opposing end portion, and a bore therethrough, wherein a portion of an outside surface of the second end portion includes threads thereon, an inner nose with a first end portion, a second, opposing end portion, and a bore therethrough, wherein the first end portion is configured to be receivable by the bore of the annular body, an outer nose with a first end portion, a second, opposing end portion, and a bore therethrough, wherein the bore of the outer nose is configured to telescopically receive the inner tube and the first end portion of the outer nose is configured to be receivable by the bore of the annular body, and an annular nut having a first end portion, a second, opposing end portion, and a bore therethrough, wherein the bore is configured to receive a portion of the concentric inner and outer tubes with the second end portion of the outer nose positioned between the concentric inner and outer tubes, and wherein at least a portion of a surface defining the bore includes threads thereon, and the threads of the annular nut are configured to engage with the threads of the annular body.

Another embodiment of the present invention comprises a method for joining the ends of concentric inner and outer tubes to a fitting, the method comprising compressing a flared end of the inner tube between an inner nose and an outer nose, compressing a flared end of the outer tube between the outer nose and an annular nut, and threading the annular nut to an annular body, with the inner and outer tubes and the inner and outer noses positioned therebetween.

Still another embodiment of the present invention comprises a method of forming a kit for a double containment fitting, including molding an inner nose comprising a first end portion, a second end portion, and a bore therethrough, molding an outer nose comprising a first end portion, a second end portion, and a bore therethrough, molding an annular body comprising a first end portion, a second end portion, a bore therethrough, and at least one flexible wall section positioned between the first end portion and the second end portion, wherein the bore is configured to receive the first end portion of the inner nose and the first end portion of the outer nose, and molding an annular nut configured to couple with the annular body.

Yet another embodiment of the present invention comprises a double containment system including an outer tube having a flared end, an inner tube extending through the outer tube and having a flared end, and a double containment fitting closing the flared end of the outer tube and joining the flared end of the inner tube in fluid communication with a passageway therethrough, the double containment fitting comprising: an annular body with a first end portion, a second, opposing end portion, and a bore therethrough, wherein a portion of an outside surface of the second end portion includes threads thereon; an inner nose with a first end portion, a second, opposing end portion, and a bore therethrough, wherein the first end portion is configured to be receivable by the bore of the annular body; an outer nose with a first end portion, a second, opposing end portion, and a bore therethrough, wherein the bore of the outer nose is configured to telescopically receive the inner tube and the first end portion of the outer nose is configured to be receivable by the bore of the annular body; and an annular nut having a first end portion, a second, opposing end portion, and a bore therethrough, wherein the bore is configured to receive a portion of the concentric inner and outer tubes with the second end portion of the outer nose positioned between the concentric inner and outer tubes, and wherein at least a portion of a surface defining the bore includes threads thereon, and the threads of the annular nut are configured to engage with the threads of the annular body.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1A shows an exploded cross-sectional view of an embodiment of a double containment fitting of the present invention;

FIG. 1B depicts a cross-sectional view of an embodiment of an annular body of the present invention;

FIG. 1C depicts a side view of the annular body of FIG. 1B;

FIG. 1D depicts a cross-sectional view of an embodiment of an annular nut of the present invention;

FIGS. 2-4 show cross-sectional views of the double containment fitting of FIG. 1A in partially assembled states;

FIG. 5 shows a cross-sectional view of the double containment fitting of FIG. 1A in an assembled state;

FIG. 6 shows a cross-sectional view of an embodiment of an annular body of the present invention;

FIG. 7 shows a cross-sectional view of another embodiment of an annular body of the present invention; and

FIG. 8 is a simplified sketch used to illustrate embodiment of methods of the present invention for making and/or assembling a double containment fitting.

### DETAILED DESCRIPTION OF THE INVENTION

Referring in general to the accompanying drawings, various aspects of the present invention are illustrated in the context of embodiments of a fitting and methods for assembling such a fitting with concentric tubes. Common elements of the illustrated embodiments are designated with like reference numerals. It should be understood that the figures presented are not meant to illustrate actual views of any particular portion of a particular fitting, but are merely idealized schematic representations which are employed to more clearly and fully depict the invention.

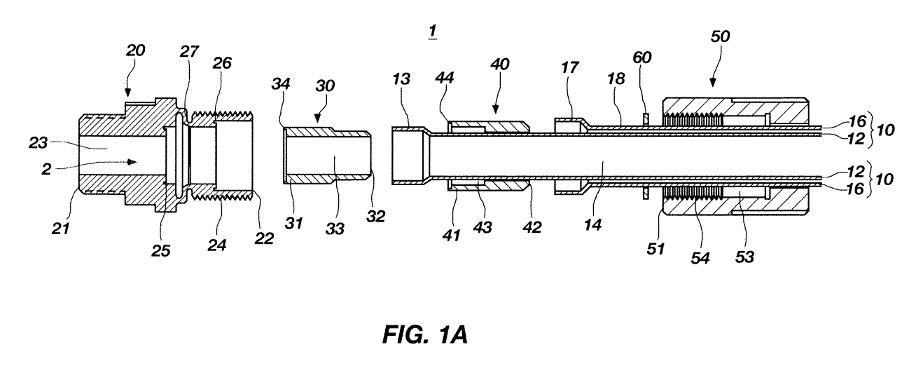

FIG. 1 depicts an exploded cross-sectional view of a first embodiment of a double containment fitting of the present invention. The fitting 1 may be used with concentric tubing 10. The concentric tubing 10 may include an inner tube 12 and an outer tube 16. The inner tube 12 may be at least partially received within the outer tube 16. The inner tube 12 may have a flared end 13, and the outer tube may have a flared end 17. The concentric tubing 10 may be used for transporting fluids. The double containment fitting 1 enables the flared ends 13, 17 of either or both the inner tube 12 and outer tube 16 to be engaged and/or sealed within the double containment fitting 1. The flared end 17 of the outer tube 16 may be closed from fluid communication in the double containment fitting 1, and a passageway 14 through the inner tube 12 may be in fluid communication with an opening 2 of the double containment fitting 1.

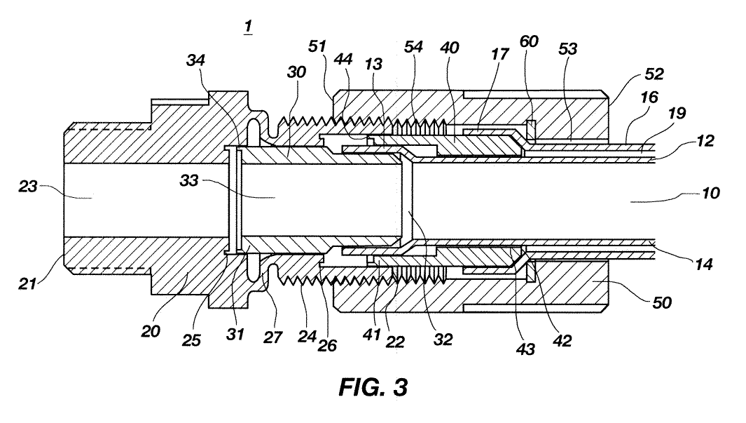

The double containment fitting 1 includes an annular body 20, an inner nose 30, an outer nose 40, and an annular nut 50. FIG. 5 shows the double containment fitting 1 and the concentric tubing 10 in an assembled state. As shown in FIG. 5, the inner nose 30 may be at least partially inserted within the flared end 13 of the inner tube 12, and the outer nose 40 may encircle a section of the inner tube 12 and be partially inserted within the flared end 17 of the outer tube 16 in the assembled state. The inner nose 30, the inner tube 12, the outer nose 40, and the outer tube 16 may be at least partially telescopically positioned within the annular nut 50 in the assembled state. The annular nut 50 and the annular body 20 may be joined with a threaded connection. In other embodiments, the annular nut 50 and the annular body 20 may be joined with a snap-fit (or other mechanical interference connection), using an adhesive, or by forming a direct bond between the annular nut 50 and the annular body 20 (e.g., using a thermal bonding process or an ultrasonic bonding process).

The inner tube 12, outer tube 16, annular body 20, inner nose 30, outer nose 40, and annular nut 50 may be formed of any material possessing good chemical and thermal resistance and capable of accommodating the types of fluids, pressures, temperatures, etc. to which the double containment fitting 1 may be exposed. Suitable materials include, but are not limited to, polymeric materials. As a nonlimiting example, these components may be formed from fluoromer materials such as, for example, tetrafluoroethylene (TFE), polytetrafluoroethylene (PTFE), fluorinated ethylene-propylene (FEP), perfluoroalkoxy fluorocarbon resin (PFA), polychlorotrifluoroethylene (PCTFE), ethylene-chlorotrifluoroethylene copolymer (ECTFE), ethylene-tetrafuoroethylene copolymer (ETFE), polyvinylidene fluoride (PVDF), and polyvinyl fluoride (PVF). Many other polymer materials also may be used including, for example, polyvinyl chloride (PVC), chlorinated polyvinyl chloride (CPVC), polypropylene, polyethelyne, high density polyethylene, acrylonitrile butadiene styrene (ABS), a thermal setting plastic, a thermal plastic, or a plastic with property enhancing additives.

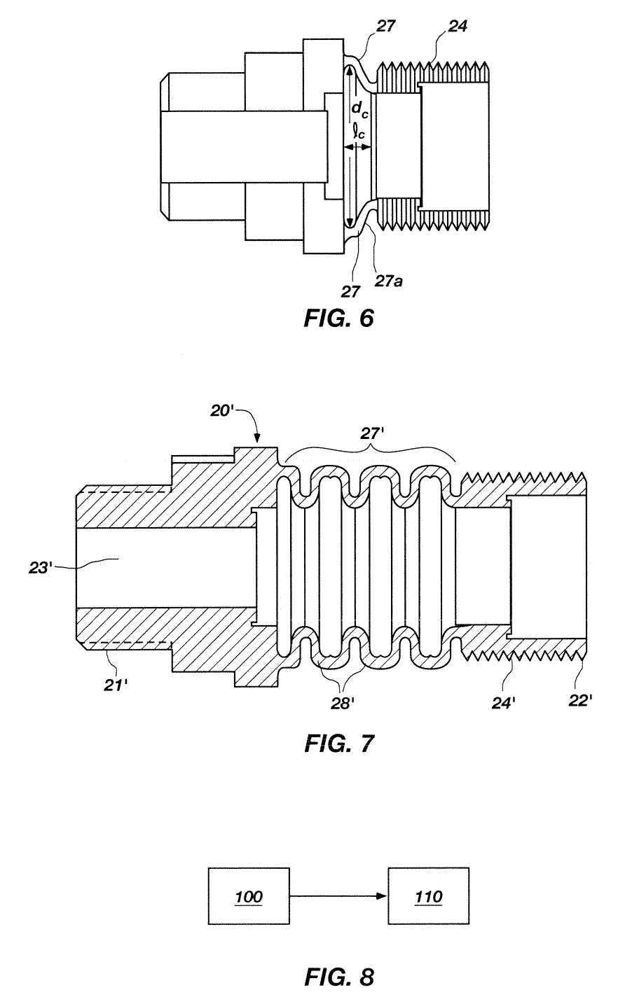

The inner tube 12, outer tube 16, annular body 20, inner nose 30, outer nose 40, and annular nut 50 may be formed using, for example, a molding process (e.g., compression molding, injection molding, transfer molding, etc.). Optionally, features such as threads may be added to molded parts using machining processes (e.g., turning, milling, and drilling), which may comprise computer numerical control (CNC) processes. FIG. 8 depicts a method of making the components of the double containment fitting 1. The components may be molded (act 100) and then threads 24, 54 by be formed in the annular nut 50 and the annular body 50 (act 110).

FIG. 1B is an enlarged cross-sectional view of the annular body 20 shown in FIG. 1A. The annular body 20 may include a first end 21, an opposing second end 22, and a bore 23 that extends through the annular body between the first end 21 and the second end 22. The annular body 20 may be configured to at least partially telescopically receive the inner nose 30, the flared end 13 of the inner tube 12, and the outer nose 40.

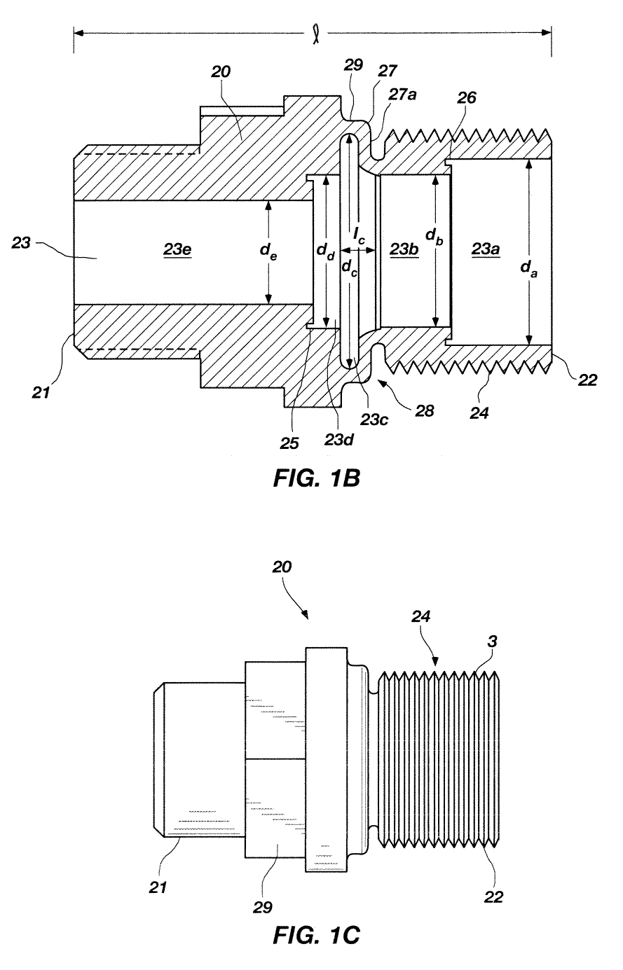

The bore 23 of the annular body 20 comprises multiple portions. A first end portion 23a is configured to receive the outer nose 40 and may include an annular groove 26 for mating with an annular lip 44 (see FIG. 2) of the outer nose 40 and forming a fluid-tight seal therebetween. A second portion 23b of the bore 23 has a diameter d_{b} smaller than a diameter dₐ of the first end portion 23a. The diameter db of the second portion 23b of the bore 23 may be smaller than the outside diameter of the outer nose 40. Thus, the outer nose 40 may not be inserted within the bore 23 beyond the first portion 23a.

A third portion 23c of the bore 23 may be defined by a flexible wall 27 of the annular body 20. The length l_{c} the third portion 23c of the bore 23 may change as forces are applied to the annular body 20 during assembly of the double containment fitting 1, as further described hereinbelow. The diameter d_{c} of the third portion 23c of the bore 23 may change along the length l_{c} of the third portion 23c. The inner surface of the annular body 20 in the third portion 23c may thus have a tapered profile, as shown in FIG. 1B. The flexible wall 27 may be thinner than other walls of the annular body 20 to enable the flexible wall 27 to deform under longitudinal tension on the annular body 20. The outside surface 29 of the annular body 20 may fold radially inwardly at the flexible wall 27, then folds radially outwardly again to meet the threads 24 of the annular body 20. In other words, the portion of the annular body 20 that defines the third portion 23C of the bore 23 may comprise one or more bends, folds, or flutes 28 to facilitate deformation (e.g., flexing) thereof.

A fourth portion 23d of the bore 23 may be configured to receive a first end portion 31 of the inner nose 30. The fourth portion 23d of the bore 23 may include an annular groove 25 for mating with an annular lip 34 (see FIG. 2) of the inner nose 30 and forming a fluid-tight seal therebetween. A fifth portion 23e of the bore 23 may have a diameter dₑ smaller than a diameter d_{d} of the fourth portion 23d. The diameter dₑ of the fifth portion 23e of the bore 23 may be smaller than the outside diameter of the inner nose 30. Thus, the inner nose 30 may not be inserted within the bore 23 beyond the fourth portion 23d.

FIG. 1C depicts a side view of the annular body 20. The annular body 20 may include one or more flat surfaces 29 (which, optionally, may define a hexagonal outer profile) configured to enable a tool (e.g., a wrench) to be used to provide relative rotation between the annular body 20 and the annular nut 50 (FIG. 1). The first end 21 of the annular body 20 may be configured for coupling to an external component (not shown). An outside surface 3 of the second end 22 of the annular body 20 may include threads 24 thereon that are configured to engage with complementary threads 54 on the annular nut 50 (FIG. 1).

Returning to FIG. 1, the inner nose 30 comprises a first end portion 31, an opposing second end portion 32, and a bore 33 extending through the inner nose 30 between the first end portion 31 and the second end portion 32. The first end portion 31 of the inner nose 30 may have an outside diameter larger than an outside diameter of the opposing second end portion 32 of the inner nose 30. The bore 33 may have a substantially uniform diameter therethrough. The first end portion 31 of the inner nose 30 is configured to be received within the bore 23 of the annular body 20. The opposing, second end portion 32 of the inner nose 30 may be inserted into the flared end 13 of the inner tube 12. The first end portion 31 of the inner nose 30, having a larger outside diameter than both the opposing, second end portion 32, and the inside diameter of the flared end 13 of the inner tube 12 may prevent the inner nose 30 from being inserted too far longitudinally into the flared end 13 of the inner tube 12. The diameter of the passageway 14 extending through the inner tube 12 may be substantially similar to the diameter of the bore 33 extending through the inner nose 30. Thus, there is an at least substantially continuous fluid flow passage extending through the inner nose 30 and the inner tube 12 when the second end portion 32 of the inner nose 30 is inserted into the flared end 13 of the inner tube 12.

The outer nose 40 may comprise a first end portion 41, an opposing, second end portion 42, and a bore 43 extending through the outer nose 40 between the first end portion 41 and the second end portion 42. The first end portion 41 of the outer nose 40 is configured to be received within the bore 23 of the annular body 20. In the assembled state (FIG. 5), the outer nose 40 may at least partially encircle the second end portion 32 of the inner nose 30, and the flared end 13 of the inner tube 12 may be disposed between the first end portion 41 of the outer nose 40 and the second end portion 32 of the inner nose 30. The bore 43 within the first end portion 41 of the outer nose 40 may have a diameter larger than the diameter of the bore 43 within the opposing, second end portion 42 of the outer nose 40. The flared end 13 of the inner tube 12 may be received by the bore 43 within the first end portion 41 of the outer nose 40. The flared end 13 of the inner tube 12 may have a larger outside diameter than the bore 43 within the opposing, second end portion 42 of the outer nose 40. Thus, the outer nose 40 may be prevented from traveling longitudinally beyond the flared end 13 of the inner tube 12. The opposing, second end portion 42 of the outer nose 40 may be configured to be at least partially received by the flared end 17 of the outer tube 16.

The annular nut 50 may at least partially telescopically receive the outer tube 16, which in turn at least partially receives the outer nose 40 and the inner tube 12. The second end portion 32 of the inner nose 30 may be at least partially telescopically received by the inner tube 12, and the first end portion 31 of the inner nose 30 may be at least partially telescopically received by the annular body 20. The annular nut 50 may engage with the annular body 20 to seal the double containment fitting. The annular nut 50 may include a first end 51, an opposing second end 52, and a bore 53 extending through the annular nut 50 between the first end 51 and the second end 52.

FIG. 1D is an enlarged cross-sectional view of the annular nut 50. The bore 53 of the annular nut 50 may be defined by an inside surface 56 of the annular nut 50. A portion of the inside surface 56 may include threads 54 complementary to, and configured to engage with, the threads 24 of the annular body 20.

The bore 53 of the annular nut 50 may include multiple portions or sections. A first portion 53a of the bore 53 is configured to telescopically receive the outer tube 16, but the diameter d₅₃ₐ of the first portion 53a of the bore 53 is too small to receive the flared end 17 of the outer tube 16. The annular nut 50 may, in some embodiments, comprise an annular gripper 60, which may be inserted into the second portion 53b of the bore 53, and which is described in further detail hereinbelow. A third portion 53c of the bore 53 may be configured to telescopically receive the flared end 17 of the outer tube 16. A fourth portion 53d of the bore 53 may be defined by or comprise the threads 54 on the inside surface 56 of the annular nut 50.

An annular gripper 60 may be positioned within the bore 53 of the annular nut 50. The annular gripper 60 may be configured to grip an outer surface of the outer tube 16. The annular gripper 60 may be or comprise a ring (e.g., a split ring), and may comprise a softer material than the material of the annular nut 50. The softer material of the annular gripper 60 may more readily conform to the surface of the outer tube 16. The annular gripper 60 may be positioned in the second portion 53b of the bore 53 of the annular nut 50, between the third portion 53c and the first portion 53a. The diameters of the second portion 53b and the third portion 53c may be larger than the diameter of the first portion 53a. Thus, the gripper 60 may contact a longitudinally facing inner wall 55 of the annular nut 50.

A manner in which the double containment fitting 1 may be assembled with the inner tube 12 and the outer tube 16 is described below with reference to FIGS. 2-4, each of which depicts the double containment fitting 1, the inner tube 12, and the outer tube 16 in a partially assembled state.

Referring to FIG. 2, the second end portion 32 of the inner nose 30 may be inserted into the flared end 13 of the inner tube 12, and the first end portion 31 of the inner nose 30 may be inserted into the bore 23 of the annular body 20. The second end portion 42 of the outer nose 40 may be inserted into the flared end 17 of the outer tube 16, and the first end portion 41 of the outer nose 40 may be inserted into the bore 23 of the annular body 20 and positioned over the flared end 13 of the inner tube 12 and the second end portion 32 of the inner nose 30. The annular nut 50 may be positioned over the outer tube 16, and the first end 51 of the annular nut 50 may be positioned over the flared end 17 of the outer tube 16.

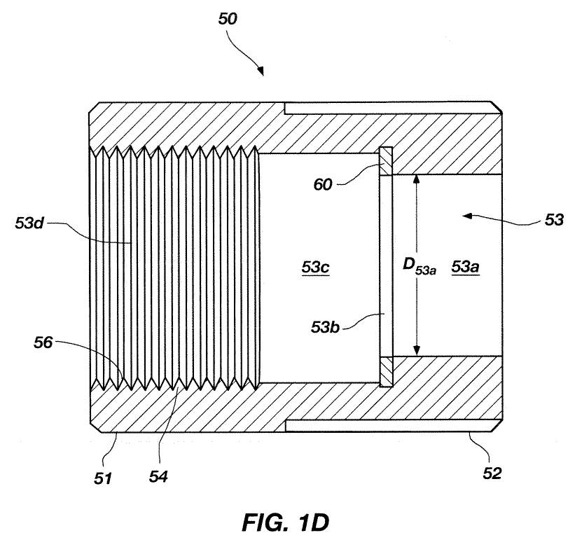

Turning to FIG. 3, the annular nut 50 may be threaded onto the annular body 20. As the threads 54 of the annular nut 50 are threaded onto the threads 24 of the annular body 20, the annular nut 50 will slide relative to and over the annular body 20 (i.e., in the leftward direction of FIG. 3). As the annular nut 50 will slide relative to and over the annular body 20, the annular gripper 60 will abut against and grip the outer tube 16 at the junction between the flared end 17 and the body portion 18 of the outer tube 16, thus retaining the outer tube 16 in the annular nut 50.

Optionally, a surface of the annular gripper 60 may include a plurality of annular ridges (not shown), arranged in a stair-step manner to approximate the angle of a surface of the shoulder region of the outer tube 16, between the flared end 17 and the body portion 18. The plurality of annular ridges may seize the outer tube 16 shoulder surface, retaining the outer tube 16 in place within the annular nut 50.

FIG. 3 depicts the threads 54 of the annular nut 50 partially engaged with the threads 24 of the annular body 20. The body portion 18 of the outer tube 16 is received by the first portion 53a of the bore 53 of the annular nut 50 with the flared portion 17 of the outer tube 16 in the third portion 53c of the bore 53 of the annular nut 50. The annular gripper 60 prevents the flared end 17 of the outer tube 16 from sliding through the bore 53 of the annular nut 50. The second end 42 of the outer nose 40 is received by the flared end 17 of the outer tube 16, and the inner tube 12 extends through the outer tube 16 and the bore 43 of the outer nose 40. An end of an annular passageway 19 between an outside wall of the inner tube 12 and an inside wall of the outer tube 16 is sealed at the ends of the inner tube 12 and the outer tubes 16 by the outer nose 40. The first end 31 of the inner nose 30 is received by the bore 23 of the second end 22 of the annular body 20. The second end 32 of the inner nose 30 is received by the flared end 13 of the inner tube 12. The inner tube 12 is telescopically received by the bore 43 of the outer nose 40. The first end portion 41 of the outer nose 40 is received by the bore 23 of the second end 22 of the annular body 20 and the second end 42 of the outer nose 40 is received by the flared end 17 of the outer tube 16. The outer tube 16 is telescopically received by the bore 53 of the annular nut 50, and retained therein by the annular gripper 60.

In FIG. 3, the threads 54 of the annular nut 50 are shown engaged to the threads 24 of the annular body 20. After the annular gripper 60 abuts against the flared end 17 of the outer tube 16, as the annular nut 50 and annular body 20 are further threaded together, the inner nose 30, the flared end 13 of the inner tube 12, the outer nose 40, and the flared end 17 of the outer tube 16 are longitudinally compressed together between the annular body 20 and the annular nut 50.

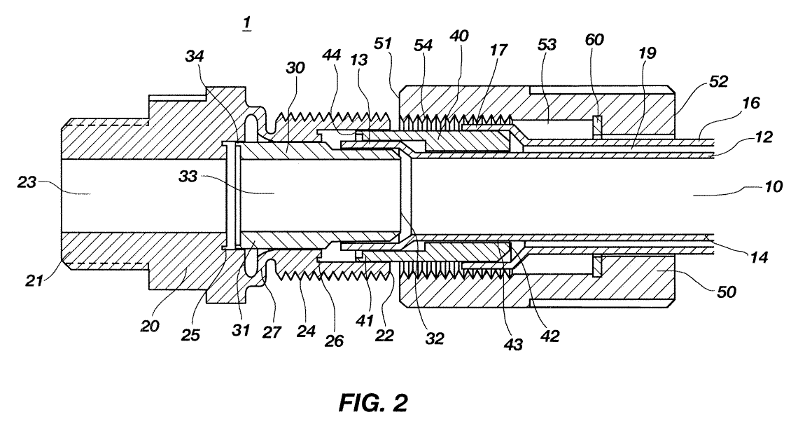

Referring to FIG. 4, threading the annular nut 50 and the annular body 20 further together (from the configuration of FIG. 3) will cause the second end portion 42 of the outer nose 40 to abut against the flared end 13 of the inner tube 12, and, in turn, cause the flared end 13 of the inner tube 12 to abut against the second end portion 32 of the inner nose 30. As the annular nut 50 is even further threaded onto the annular body, the first end portion 31 of the inner nose 30 is caused to be seated in the annular body 20 and to provide an interference fit between the annular lip 34 of the inner nose 30 and the complementary annular groove 25 of the fourth portion 23d (FIG. 1B) of the bore 23 of the annular body 20. FIG. 4 illustrates the double containment fitting 1 in this configuration, after the annular lip 34 of the inner nose 30 has been seated in the annular groove 25 of the annular body 20.

FIG. 5 depicts the annular nut 50 and the annular body 20 in the fully engaged configuration. As can be seen by comparing FIG. 5 to FIG. 4, further threading of the annular nut 50 onto the annular body 20 from the configuration of FIG. 4 will cause the flexible wall 27 of the annular body 20 to deform, which allows the second end 22 of the annular body 20 to move further toward and into the annular nut 50, while the first end 21 of the annular body 20 is prevented from moving further toward the annular but 50 due to interference between the annular gripper 60, the flared end 17 of the outer tube 16, the outer nose 40, the flared end 13 of the inner tube 12, and the inner nose 30. In other words, as the annular nut 50 is further threaded onto the annular body 20, a tensile force may be applied to the annular body 20, which may cause the flexible wall 27 to stretch in the longitudinal direction or to otherwise deform.

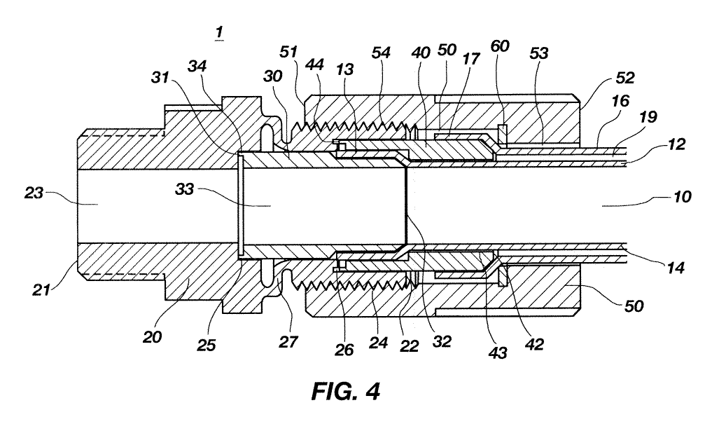

FIG. 1B illustrates the annular body 20 in a neutral configuration, with no external forces applied thereto. FIG. 6 illustrates a cut-away view of the annular body 20 under tension along a longitudinal axis of the annular body 20, as would be the case in the fully engaged configuration (shown in FIG. 5) of the double containment fitting 1. With the annular body 20 under tension, as shown in FIG. 6, the length l_{c} of the third portion 23c (FIG. 1B) of the bore 23 through the annular body 20 may increase as the flexible wall 27 stretches or deforms. Thus, the length l_{c} of the third portion 23c of the bore 23 through the annular body 20, and the length of the annular body 20 itself are greater when the annular body 20 is under tension than when no tensile forces are applied to the annular body 20. The double containment fitting 1 is configured such that the annular body 20 is placed under tension as the components of the double containment fitting 1 are assembled together with the inner tube 12 and the outer tube 16, and the annular nut 50 is threaded onto the annular body 20, and the annular body 20 is configured such that at least a portion of the annular body 20 will deform when it is placed under tension.

Referring again to FIG. 5, as the annular nut 50 is further threaded onto the annular body 20, the flexible wall 27 deforms (e.g., elastically deforms), and the second end 22 of the annular body 20 moves further into the annular nut 50 until the first end portion 41 of the outer nose 40 is seated in the annular body 20, and an interference fit is provided between the annular lip 44 of the outer nose 40 and the complementary annular groove 26 of the first portion 23a (FIG. 1B) of the bore 23 of the annular body 20. After an interference fit is provided between the annular lip 44 of the outer nose 40 and the complementary annular groove 26 of the annular body 20, the double containment fitting 1 may be in the fully-engaged configuration with the inner tube 12 and the outer tube 16. In other words, the annular body 20, the inner nose 30, the inner tube 12, the outer nose 40, the outer tube 16, and the annular nut 50 may be configured such that, as the annular nut 50 is threaded onto the annular body 20, the first end portion 41 of the outer nose 40 and the annular body 20 are the last parts to fully engage with one another. The biasing force of the flexible wall 27 of the annular body 20, when flexed, enables the components of the double containment fitting 1 to be coupled in such a manner as to provide fluid tight seals therebetween, yet the biasing force is not strong enough to strip the complementary threads 24, 54 of the annular body 20 and the annular nut 50, respectively.

In the fully engaged configuration shown in FIG. 5, the outer nose 40 provides a seal between the inner tube 12 and the outer tube 16, and seals the passageway 19 from the exterior of the outer tube 16 and the interior of the inner tube 12. Similarly, the inner nose 30 provides a seal between the inner tube 12 and the annular body 20, and seals the passageway 14 from the exterior of the inner tube 12. The passageway 14 of the inner tube 12 is in fluid communication with the bore 33 of the inner nose 30 and the bore 23 of the annular body 20.

The annular nut 50 and the annular gripper 60 engage the flared end 17 of the outer tube 16, and force the outer tube 16 toward the outer nose 40. The outer nose 40 engages the flared end 13 of the inner tube 12, and forces the inner tube 12 toward the inner nose 30. The first end portion 41 of the outer nose 40 engages with the annular body 20, which forces the outer nose 40 back against the outer tube 16, such that the flared end 17 of the outer tube 16 is pinched between the annular gripper 60 and the outer nose 40 to form a fluid-tight seal. The first end portion 31 of the inner nose 30 engages with the annular body 20, which forces the inner nose 30 back against the inner tube 12, such that the flared end 13 of the inner tube 12 is pinched between the outer nose 40 and the inner nose 30 to form a fluid-tight seal. Furthermore, the interference fit between the annular lip 34 of the inner nose 30 and the annular groove 25 of the annular body 20, and the interference fit between the annular lip 44 of the outer nose 40 and the annular groove 26 of the annular body 20, provide a fluid-tight seal that prevents fluid from flowing from the passageway 14 to the exterior of the double containment fitting 1 through a pathway extending between the annular body 20 and the inner nose 30 and between the annular body 20 and the outer nose 40.

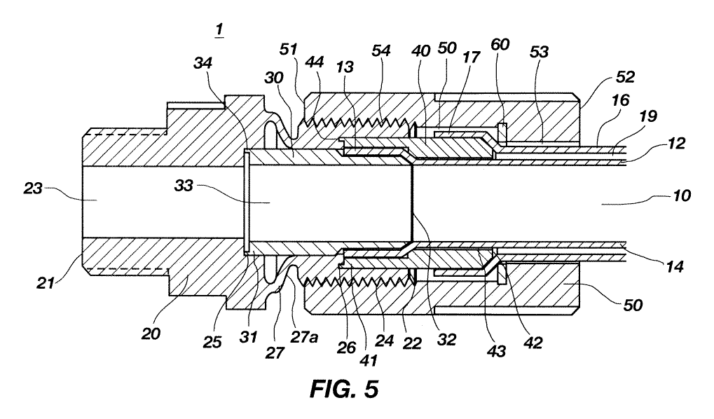

FIG. 7 depicts another embodiment of an annular body 20′ of the present invention. The annular body 20′ includes a first end portion 21′, an opposing, second end portion 22′, and a bore 23′ extending through the annular body 20′ between the first end portion 21′ and the second end portion 22′. The annular body 20′ includes a flexible wall 27′ which comprises multiple flutes 28′ or folds, which may allow the flexible wall 27′ to deform and the length of the flexible wall 27′ to increase under tension more than the length of the flexible wall 27 of the annular body 20 shown in FIG. 1B, which comprises a single flute 28.

Embodiments of double containment fittings of the present invention (such as, for example, the double containment fitting 1 shown in FIGS. 2-5) provide a seal for the end of concentric tubes using a single threaded coupling.

Although the foregoing description contains many specific details, these should not be construed as limiting the scope of the present invention, but merely as providing illustrations of some exemplary embodiments. Similarly, other embodiments of the invention may be devised which do not depart from the spirit or scope of the present invention. Moreover, features from different embodiments of the invention may be employed in combination. The scope of the invention is, therefore, indicated and limited only by the appended claims and their legal equivalents, rather than by the foregoing description. All additions, deletions, and modifications to the exemplary embodiments of the invention, as disclosed herein, which fall within the meaning and scope of the claims, are embraced thereby.

What is claimed is:

1. A double containment fitting for joining the ends of concentric tubing, comprising:
an annular body comprising:
a first end portion;
an opposing, second end portion;
a bore extending through the annular body between the first end portion and the second end portion; and
a threaded surface;
an inner nose comprising:
a first end portion sized and configured to be inserted at least partially into the bore of the annular body;
an opposing, second end portion sized and configured to be inserted into an end of a first tube; and
a bore extending through the inner nose between the first end portion of the inner nose and the second end portion of the inner nose;
an outer nose comprising:
a first end portion sized and configured to be inserted at least partially into the bore of the annular body;
an opposing, second end portion sized and configured to be inserted into an end of a second tube concentric to the first tube; and
a bore extending through the inner nose between the first end portion of the outer nose and the second end portion of the outer nose; and
an annular nut comprising:
a first end portion;
an opposing, second end portion;
a bore extending through the annular nut between the first end portion of the annular nut and the second end portion of the annular nut; and
a threaded surface configured to engage with the threaded surface of the annular body;
wherein the double containment fitting is configured to pinch the end of the first tube between the inner nose and the outer nose and to pinch the end of the second tube between the outer nose and the annular nut when the second end portion of the inner nose is inserted into the end of the first tube, the first end portion of the inner nose is inserted into the bore of the annular body, the second end portion of the outer nose is inserted into the end of the second tube, the first end portion of the outer nose is inserted into the bore of the annular body, and the threaded surface of the annular nut is engaged with the threaded surface of the annular body.

2. The double containment fitting of claim 1, wherein at least a portion of the double containment fitting is configured to elastically deform as the threaded surface of the annular nut is engaged with the threaded surface of the annular body.

3. The double containment fitting of claim 2, wherein the annular body comprises a flexible wall configured to deform as the threaded surface of the annular nut is engaged with the threaded surface of the annular body.

4. The double containment fitting of claim 3, wherein the flexible wall is disposed between a portion of the annular body configured to abut against the first end portion of the inner nose and a portion of the annular body comprising the threaded surface thereof.

5. The double containment fitting of claim 3, wherein the flexible wall is configured to elongate in a direction parallel to a longitudinal axis of the annular body as the threaded surface of the annular nut is engaged with the threaded surface of the annular body.

6. The double containment fitting of claim 4, wherein the flexible wall comprises at least one flute.

7. The double containment fitting of claim 1, wherein the first end portion of the inner nose comprises an annular lip, and a surface of the annular body comprises an annular recess complementary to the annular lip of the inner nose, and wherein an interference fit is provided between the annular lip of the inner nose and the annular recess of the annular body as the threaded surface of the annular nut is engaged with the threaded surface of the annular body.

8. The double containment fitting of claim 7, wherein the first end portion of the outer nose comprises an annular lip, and a surface of the annular body comprises an additional annular recess complementary to the annular lip of the outer nose, and wherein an interference fit is provided between the annular lip of the outer nose and the additional annular recess of the annular body as the threaded surface of the annular nut is engaged with the threaded surface of the annular body.

9. The double containment fitting of claim 8, wherein the double containment fitting is configured to first provide the interference fit between the annular lip of the inner nose and the annular recess of the annular body and subsequently provide the interference fit between the annular lip of the outer nose and the additional annular recess of the annular body as the threaded surface of the annular nut is engaged with the threaded surface of the annular body.

10. The double containment fitting of claim 1, wherein the annular nut comprises an annular gripper disposed within the bore of the annular nut, the annular gripper configured to abut against an outer surface of the outer tube.

11. The double containment fitting of claim 1, wherein each of the annular body, inner nose, outer nose, and annular nut is at least substantially comprised of a fluoropolymer material.

12. A method for joining the ends of concentric inner and outer tubes to a fitting, comprising:
compressing a flared end of the inner tube between an inner nose and an outer nose;
compressing a flared end of the outer tube between the outer nose and an annular nut; and
threading the annular nut to an annular body, with the inner and outer tubes and the inner and outer noses positioned therebetween.

12. The method of claim 11, wherein threading the annular nut to the annular body further comprises applying a longitudinal force in a first direction to the annular body through the inner nose, and applying a longitudinal force in a second, opposing direction to the annular body through threads of the annular body thereby flexing a portion of a wall of the annular body.

13. The method of claim 11, further comprising securing the outer tube within a bore of the annular nut with an annular gripper.

14. The method of claim 11, further comprising engaging an annular lip of the end of the inner nose within an annular groove of the annular body to seal a first end of the inner nose within the annular body.

15. The method of claim 11, further comprising engaging an annular lip of the end of the outer nose with an annular groove of the annular body to seal the outer nose within the annular body.

16. A method of forming a double containment fitting, comprising:
molding an inner nose comprising a first end portion, a second end portion, and a bore therethrough;
molding an outer nose comprising a first end portion, a second end portion, and a bore therethrough;
molding an annular body comprising a first end portion, a second end portion, a bore therethrough, and at least one flexible wall section positioned between the first end portion and the second end portion, wherein the bore is configured to receive the first end portion of the inner nose and the first end portion of the outer nose; and
molding an annular nut configured to couple with the annular body.

17. The method of claim 16, wherein molding the inner nose further comprises molding the first end portion to have an outside diameter greater than an outside diameter of the second end portion.

18. The method of claim 16, wherein molding the outer nose further comprises molding the bore to have a diameter within the first end portion greater than a diameter within the second end portion.

19. The method of claim 16, wherein molding the annular body further comprises molding threads on an outside surface of the second end portion.

20. A double containment system, comprising:
an outer tube having a flared end;
an inner tube extending through the outer tube and having a flared end; and
a double containment fitting closing the flared end of the outer tube and joining the flared end of the inner tube in fluid communication with a passageway therethrough, the double containment fitting comprising:
an annular body with a first end portion, a second, opposing end portion, and a bore therethrough, wherein a portion of an outside surface of the second end portion includes threads thereon;
an inner nose with a first end portion, a second, opposing end portion, and a bore therethrough, wherein the first end portion is configured to be receivable by the bore of the annular body;
an outer nose with a first end portion, a second, opposing end portion, and a bore therethrough, wherein the bore of the outer nose is configured to telescopically receive the inner tube and the first end portion of the outer nose is configured to be receivable by the bore of the annular body; and
an annular nut having a first end portion, a second, opposing end portion, and a bore therethrough, wherein the bore is configured to receive a portion of the concentric inner and outer tubes with the second end portion of the outer nose positioned between the concentric inner and outer tubes, and wherein at least a portion of a surface defining the bore includes threads thereon, and the threads of the annular nut are configured to engage with the threads of the annular body.

21. The system of claim 20, wherein the annular body includes a flexible wall portion between the first end portion of the annular body and the second end portion of the annular body.
